(19) United States
(12) Patent Application Publication
(10) Pub. No.: US 2018/0272637 A1
(43) Pub. Date: Sep. 27, 2018

(54) HYBRID SIPES AND METHODS FOR FORMING A TIRE TREAD

(71) Applicants: Robert LAWSON, Pelzer, SC (US); Sadi KOSE, Greer, SC (US)

(72) Inventors: Robert LAWSON, Pelzer, SC (US); Sadi KOSE, Greer, SC (US)

(73) Assignee: COMPAGNIE GENERALE DES ETABLISSEMENTS MICHELIN, Clermont-Ferrand (FR)

(21) Appl. No.: 15/764,768

(22) PCT Filed: Sep. 30, 2016
(86) PCT No.: PCT/US2016/054763

§ 371 Date: Mar. 29, 2018

Related U.S. Application Data
(63) Continuation of application No. PCT/US2015/053265, filed on Sep. 30, 2015.

(51) Int. Cl. B29D 30/06; B60C 11/03; B60C 11/11; B60C 11/12; B60C 11/13

(52) U.S. Cl. CPC B29D 30/0606; B60C 11/0323; B60C 11/11; B60C 11/1218; B60C 2011/1277; B60C 11/1281; B60C 11/1353; B60C 11/1369; B29D 2030/0613; B60C 11/1222

(57) ABSTRACT

The present invention includes tire treads having a plurality of lateral voids and methods of forming a tire tread having a plurality of lateral voids. The lateral voids of the tire treads each have a length extending primarily in the lateral direction of the tread, and where each of the plurality of lateral void features include a groove portion (18) and a sipe portion (26). Arranged at the bottom of each of the plurality of lateral void features is a submerged groove (28). Additionally or alternatively, each of the plurality of lateral void features include a groove bumper (32).

### CROSS-REFERENCE TO RELATED APPLICATIONS

This application claims priority to International Application No. PCT/US2015/053265, filed Sep. 30, 2015 with the U.S. Patent Office (acting as a Receiving Office), and which is hereby incorporated by reference.

### BACKGROUND OF THE INVENTION

### Field of the Invention

This invention relates generally to tire treads, and more particularly, tire treads having void features providing improved tire rolling resistance without degrading certain other tire performance measures.

### Description of the Related Art

One common problem pertaining to tires is a tire's tendency to resist rolling, which is referred to as rolling resistance. Unfortunately, current measures to reduce rolling resistance results in the degradation of tire performance in other performance measures. Accordingly, there is a need to provide treads that exhibit improve rolling resistance performance while not reducing tire performance in other measures.

### SUMMARY OF THE INVENTION

Particular embodiments of the present invention include tire treads having a plurality of lateral void features and a methods for forming a tire tread having a plurality of lateral void features.

Particular embodiments of a tire tread having a plurality of lateral void features and methods for forming the same include a tread comprising a length extending in a lengthwise direction, the lengthwise direction being a circumferential direction when the tread is arranged on a tire, a width extending in a lateral direction, the lateral direction being perpendicular to the lengthwise direction, and a thickness extending in a depthwise direction from an outer, ground-engaging side of the tread, the depthwise direction being perpendicular to both the lengthwise direction and the widthwise direction of the tread. The plurality of lateral void features each have a length extending primarily in the lateral direction of the tread, where the plurality of lateral void features are spaced apart in the lengthwise direction of the tread, and where each of the plurality of lateral void features include a groove portion and a sipe portion. The groove portion forms a groove and the sipe portion forms a sipe and each of the groove portion and the sipe portion are located at different locations along the length of the lateral void feature.

The particular embodiments of the present invention further comprise a submerged groove arranged at a bottom of each of the plurality of lateral void features and/or where each of the plurality of lateral void features includes a groove bumper. The submerged groove has a length extending along the length of each corresponding lateral void feature and is spaced apart from the outer, ground-engaging side of the tread by a portion of the tread thickness. The groove bumper comprises a protrusion that extends substantially across the width of the groove portion to prevent the groove from collapsing or closing during tire operation. The groove bumper includes a sipe arranged at a location along the length of the protrusion and extends across the full width and height of the protrusion to form a discontinuity across a cross-section of the bumper.

The foregoing and other embodiments, objects, features, and advantages of the invention will be apparent from the following more detailed descriptions of particular embodiments of the invention, as illustrated in the accompanying drawings wherein like reference numbers represent like parts of the invention.

### DETAILED DESCRIPTION OF THE DRAWINGS

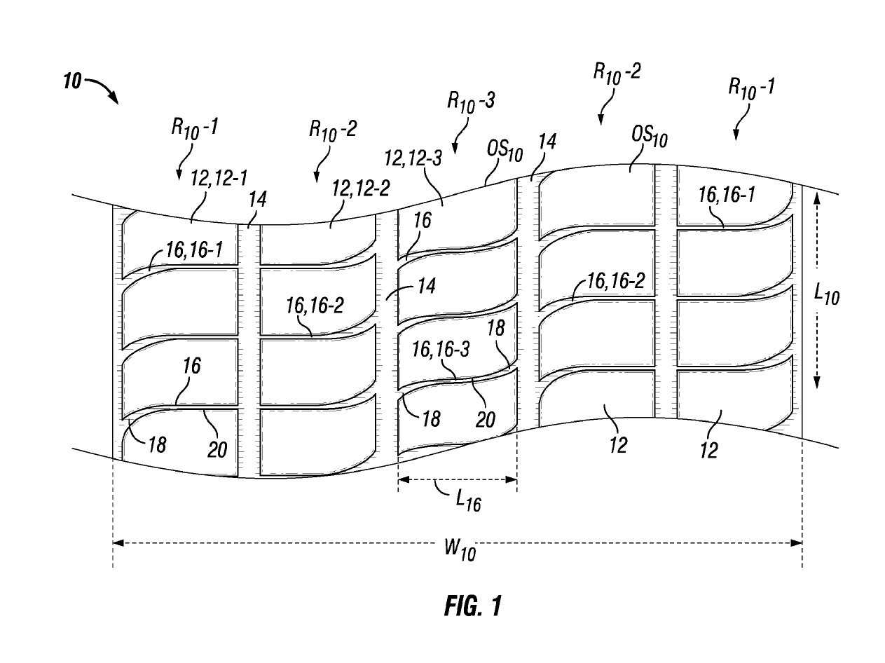

FIG. 1 is a partial top view of a tire tread showing a plurality of tread blocks separated by lateral void features and longitudinal grooves, the longitudinal grooves separating the plurality of tread blocks into five separate ribs, in accordance with an embodiment of the invention.

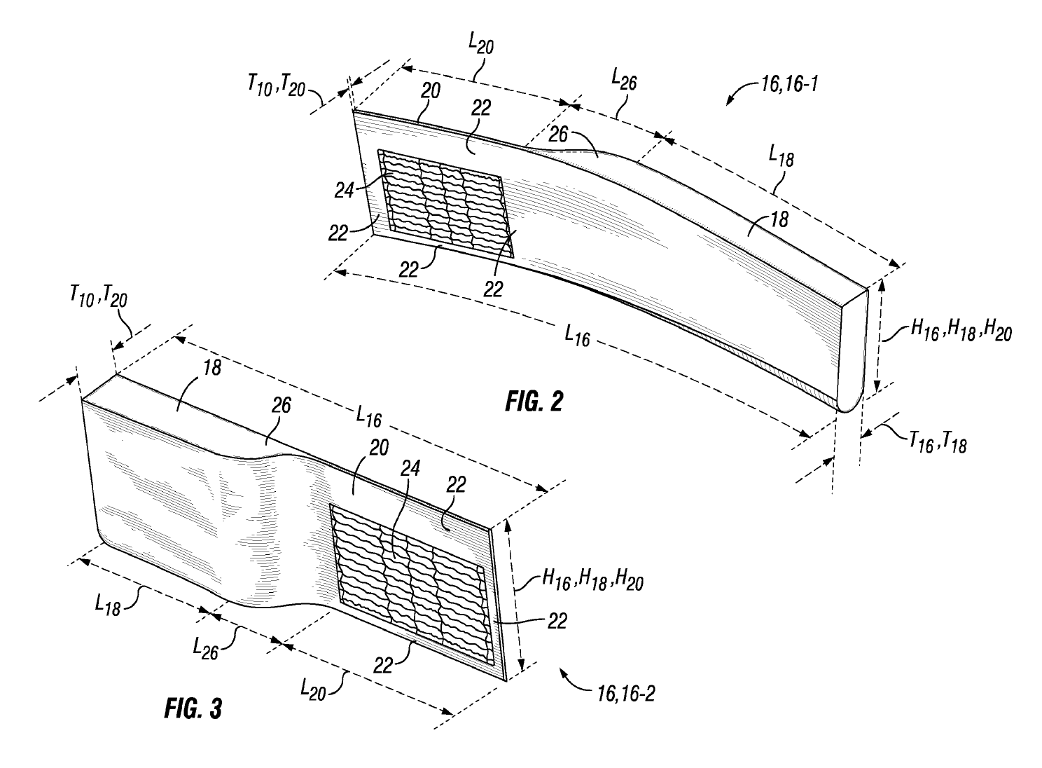

FIG. 2 is a perspective view of a lateral void feature depicting the volume of void associated with a shoulder lateral void feature as contained in the tread of FIG. 1, in accordance with a particular embodiment of the invention.

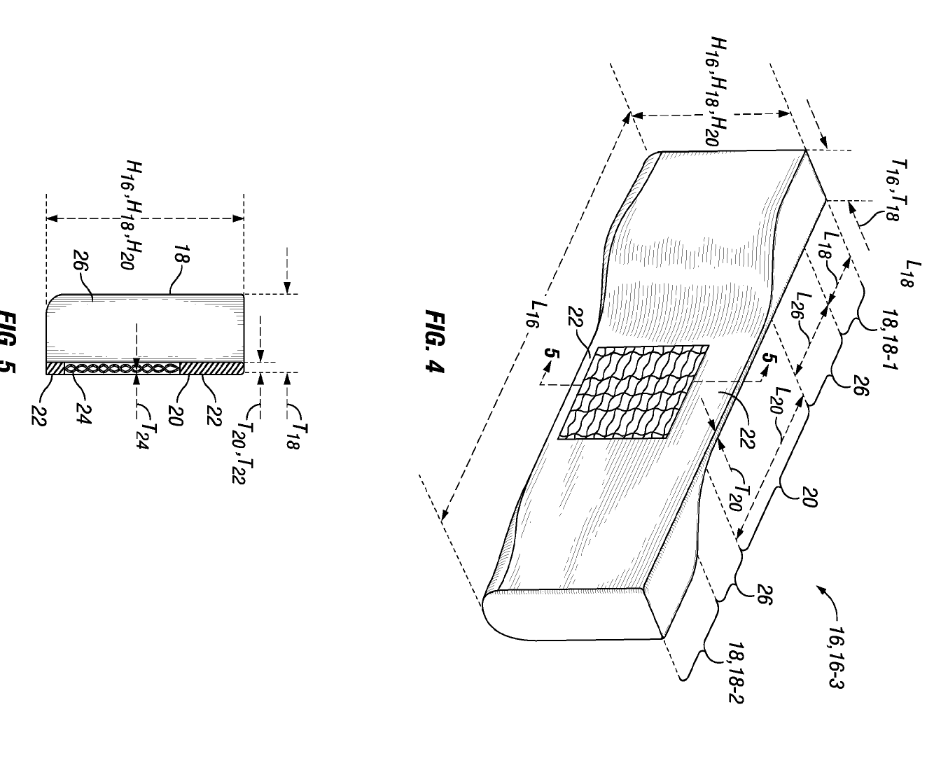

FIG. 3 is a perspective view of a lateral void feature depicting the volume of void associated with an intermediate lateral void feature as contained in the tread of FIG. 1, in accordance with a particular embodiment of the invention.

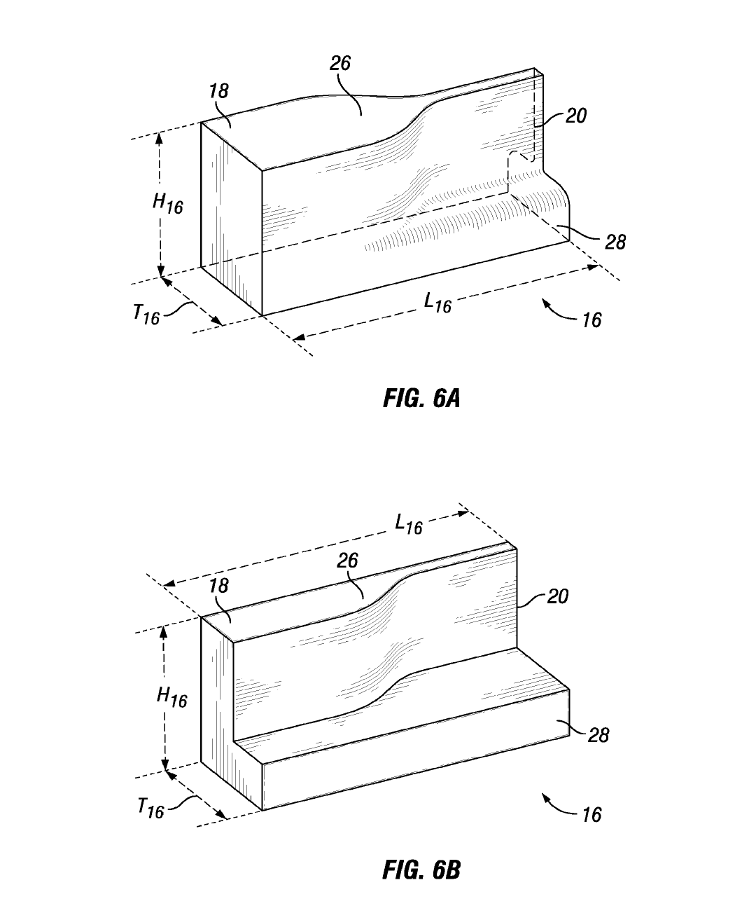

FIG. 4 is a perspective view of a lateral void feature depicting the volume of void associated with a center lateral void feature as contained in the tread of FIG. 1, in accordance with a particular embodiment of the invention.

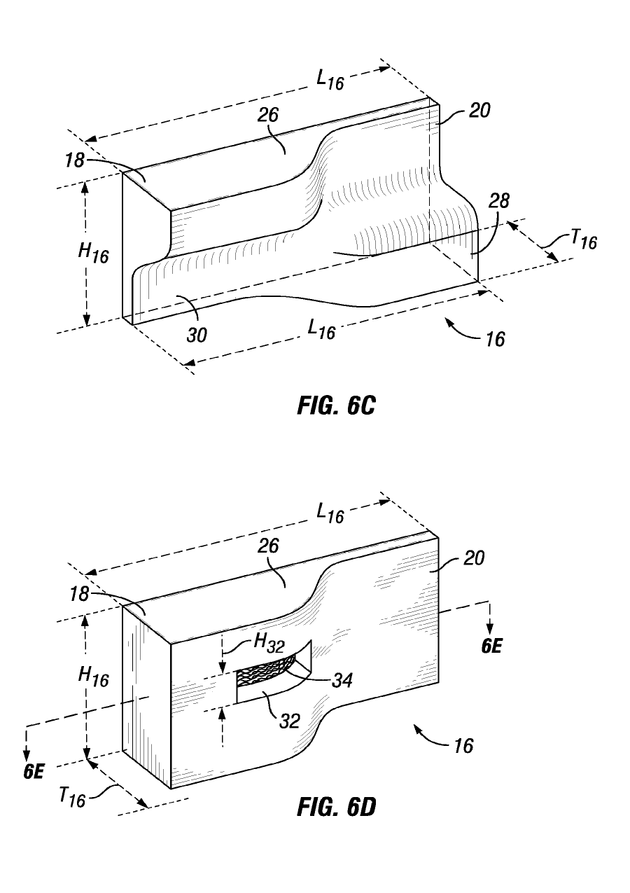

FIG. 5 is a cross-sectional view of a sipe portion taken along line 5-5 in FIG. 4.

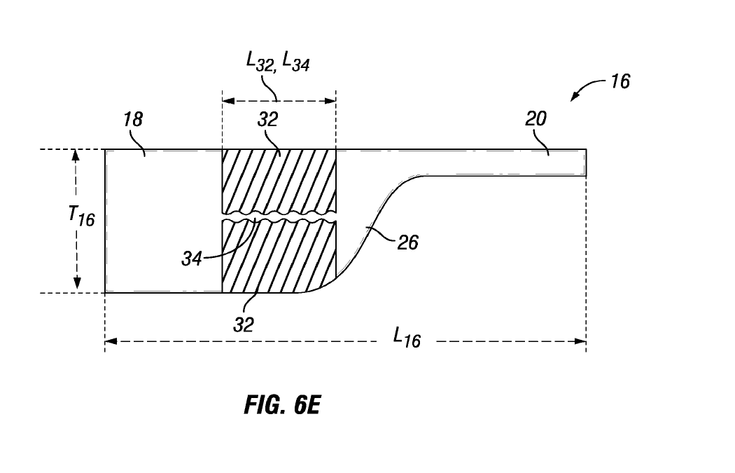

FIG. 6A is a perspective view of an alternative lateral void feature, in accordance with a particular embodiment of the invention.

FIG. 6B is a perspective view of an alternative lateral void feature, in accordance with a particular embodiment of the invention.

FIG. 6C is a perspective view of an alternative lateral void feature, in accordance with a particular embodiment of the invention.

FIG. 6D is a perspective view of an alternative lateral void feature, in accordance with a particular embodiment of the invention.

FIG. 6E is a sectional view of the alternative lateral void feature shown in FIG. 6D, taken along line 6E-6E, in accordance with a particular embodiment of the invention.

### DETAILED DESCRIPTION OF PARTICULAR EMBODIMENTS

The present invention includes methods for forming a tire tread, tire treads, and tires including said treads, where any such tread includes a plurality of lateral void features, where each of the lateral void features include a groove and a sipe arranged at different locations along the length of the lateral void feature.

By virtue of employing the lateral void features discussed herein, traditional lateral grooves are combined with sipes to form a single tread void feature—a lateral void feature. In doing so, in lieu of using traditional lateral grooves, the resulting tread has increased compressive rigidity (as a result of a reduced Poisson effect) which aids in improving rolling resistance, while also improving performance in dry braking and wear performance and without significantly impacting other performance measures, such as snow traction and wet braking, for example. Additionally, with regard to the molding member used to form these lateral void features, the mold member exhibits increased durability by connecting the thicker groove-forming portion to the thinner sipe-forming portion, as the sipe-forming member alone is typically less durable as it is characterized as being relatively thin. Moreover, by virtue of the additional stiffness provided by attachment of the groove-forming portion, the sipe-forming portion may be made even thinner, where thinner sipes offer various performance benefits in the resulting tire tread.

With regard to the tire treads described herein, it is appreciated that each such tread includes a length, width, and thickness. The length extends in a lengthwise direction. As the tread may be formed with the tire, or separately for later installation on the tire, such as during retreading operations, for example, the lengthwise direction of the tread is a circumferential (that is, annular) direction when the tread is arranged on a tire. The width extends in a lateral direction, the lateral direction being perpendicular to the lengthwise direction, while the thickness extends in a depthwise direction from an outer, ground-engaging side of the tread, the depthwise direction being perpendicular to both the lengthwise direction and the widthwise direction of the tread.

As to the inventive methods for forming a tire tread, such methods include molding a plurality of lateral void features. As each of the discontinuities are lateral void features, each of the plurality of lateral void features have a length extending primarily in the lateral direction of the tread. By extending primarily in the lateral direction of the tread, it is appreciated that the length of each lateral void feature extends in a lengthwise direction that on average extends primarily in the lateral direction of the tread, where primarily connotes that when separating the average lengthwise direction of the lateral void feature into a lateral vector and a longitudinal vector, where the lateral vector extends completely in the lateral direction of the tread and is perpendicular to the longitudinal vector, which extends in the longitudinal direction of the tread, the lateral vector is greater than the longitudinal vector. In other words, the average lengthwise direction of the lateral void feature is extends in a direction biased from the lateral direction of the tread in direction of the tread length. It is also noted that the plurality of lateral void features are spaced apart in the lengthwise direction of the tread.

It is appreciated that each of the plurality of lateral void features formed in such methods include a groove portion and a sipe portion. The groove portion is a groove (that is, a lateral groove) and the sipe portion is a sipe (that is, a lateral sipe), the groove or groove portion having a thickness that is greater than a thickness of the sipe or sipe portion. Each of the groove portion and the sipe portion are located at different locations along the length of the lateral void feature and are in fluid communication with each other, by virtue of being a part of the same discontinuity. In other words, for each lateral void feature, the groove portion and the sipe portion are arranged along the length of the lateral void feature and are fluidly connected as each forms a portion of the lateral void feature length. It is appreciated that each lateral void feature may include two or more groove portions spaced apart along the length of the lateral void feature as desired. It is also appreciated that each lateral void feature may include two or more sipe portions spaced apart along the length of the lateral void feature as desired. Each lateral void feature may form any desired shape, size, and configuration to achieve any desired tire performance result, so long as the lateral void feature includes both a groove and a sipe. Additionally, other variations of the lateral void feature are contemplated. For example, a location of increased thickness, such as a groove or thickened sipe, or a location of reduced thickness, such as a sipe or narrow groove, may be connected to, or included with, any of the groove portion, transitional portion, if present, and, sipe portion. For example, in particular embodiments, the thickened portion forms a submerged groove arranged at a bottom of each of the plurality of lateral void features, the submerged groove having a length extending along the full or partial length of each corresponding lateral void feature and being spaced apart from the outer, ground-engaging side of the tread by a portion of the tread thickness. Moreover, the lateral void feature may include other features, such as stone ejectors and/or groove bumpers, for example. Groove bumpers provide a protrusion that extends substantially across the width of a groove, to prevent the groove from collapsing or closing during tire operation. For example, in particular embodiments, each of the plurality of lateral void features includes a groove bumper comprising a protrusion that extends substantially across the width of the groove portion, the groove bumper including a sipe arranged at a location along the length of the protrusion and extending across the full width and height of the protrusion to form a discontinuity across a cross-section of the bumper. Exemplary embodiments of these lateral void features are shown in the figures of this application and will be discussed in further detail below.

In particular embodiments, each of the plurality of lateral void features include a transitional portion extending between and connecting the groove portion and the sipe portion, the transitional portion having a variable thickness that varies along the length of the corresponding lateral void feature. It is appreciated that the variable thickness of the transitional portion is measured in a direction perpendicular to both the length and a height of the corresponding lateral void feature. In extending between and connecting the groove and sipe portions, the thicker groove tapers in some shape or form to the narrower sipe. This taper or transition (that is, the variable thickness) may occur in any constant or linear manner, or in any variable or non-linear manner, as the transitional portion extends from the groove portion and to the sipe portion and/or as the transitional portion extends in the depthwise direction of the tread. As used herein, non-linear includes curvilinear and undulating extension paths.

It is appreciated that the groove and sipe may each be shaped in any manner. In other words, each of the groove and sipe portions extend in any direction in a constant or variable manner. For example, in particular embodiments, each of the groove and sipe portions have a constant cross-section taken along any one or more planes. In lieu of having a constant cross-section taken across a particular plane, the thickness of the groove portion varies across any such plane. For example, in particular embodiments, the thickness of the groove portion and/or sipe portion varies linearly or non-linearly as each extends in the depthwise direction of the tread and/or as each extends along the length of the lateral void feature. Additionally, regardless as to whether the thickness is constant or variable, in certain embodiments, the cross-sectional thickness of any one or both of the groove or sipe portions extends linearly or non-linearly as each extends in the depthwise direction of the tread and/or as each extends along the length of the lateral void feature.

With further regard to the sipe portion (that is, the sipe) of the lateral void feature, in particular embodiments, the sipe portion includes a thick portion extending at least partially around a perimeter of a reduced thickness portion. In certain variations, the thick portion extends substantially or fully around the perimeter of the reduced thickness portion. It is appreciated that the reduced thickness portion, in certain embodiments, is 0.1 to 0.4 millimeters (mm) or less, while the thick portion is greater than 0.4 mm and up to 10 mm thick. In certain embodiments, the length of the thin portion is 10% to 80% of the tread block width while the length of the thick portion is 20% to 90% of the tread block width. As noted previously, the sipe portion may extend in any direction in a constant or variable manner. In the embodiments where the sipe portion includes thick and reduced thickness portions, the thickness of any one or both of the thick or reduced thickness portions of the sipe portion may be constant or variable, and may vary linearly or non-linearly as each extends in the depthwise direction of the tread and/or as each extends along the length of the lateral void feature. Additionally, regardless of whether the thickness is constant or variable, in certain embodiments, the cross-sectional thickness of any one or both of the thick or reduced thickness portions of the sipe portion extends linearly or non-linearly as each extends in the depthwise direction of the tread and/or as each extends along the length of the lateral void feature.

It is appreciated that each of the lateral void features can be formed from one or more molding elements. In certain embodiments, each of the lateral void features is formed from one of a plurality of single molding elements. The single molding element includes a groove-forming portion for forming the groove portion and a sipe-forming portion for forming the sipe portion, the groove-forming portion and the sipe-forming portion each being located at different locations along a length of the molding element. The single molding element may be formed by assembling and connecting two or more components to form a unitary single molding element or may be formed of one continuous component to form a monolithic single molding element. Any known methods for forming a molding element for use in molding tire treads may be employed. For example, laser sintering techniques may be used. In certain embodiments, three dimensional (3-D) printing techniques are employed to form each single molding element.

It is appreciated, that any lateral void feature contemplated herein may be arranged as a longitudinal void feature, to provide a plurality of longitudinal void features each having a groove portion and a sipe portion, where any lateral void feature contemplated herein is arranged to have a length extending primarily in the longitudinal direction of the tread, in lieu of extending primarily in the lateral direction of the tread.

Particular embodiments of the tire treads and methods discussed above will now be described in further detail below in association with the figures filed herewith exemplifying the performance of the methods in association with particular embodiments of the tires.

With reference to FIG. 1, in an exemplary embodiment, a tire tread 10 is shown having a plurality of tread blocks 12 separated by longitudinal grooves 14 and lateral void features 16, the longitudinal grooves separating the plurality of tread blocks into five separate ribs R₁₀ extending in a direction of the tread length L₁₀, which is referenced as the lengthwise direction of the tread. The lengthwise direction is a circumferential direction when the tread is arranged on a tire, but may form any other linear or non-linear direction when the tread is formed separately from the tire and prior to installation there on. The tread also has a width W₁₀ extending in a lateral direction, the lateral direction being perpendicular to the lengthwise direction L₁₀ and a depthwise direction of the tread. The tread also has a thickness T₁₀ extending in a depthwise direction from an outer, ground-engaging side OS₁₀ of the tread, the depthwise direction being perpendicular to both the lengthwise direction and the widthwise direction of the tread. Because the outer, ground-engaging side OS₁₀ is configured to engage a ground surface during tire operation, the outer, ground-engaging side includes a ground-contacting surface.

With continued reference to the embodiment of FIG. 1, each of a plurality of lateral void features 16 each has a length L₁₆ extending primarily in the lateral direction W₁₀ of the tread 10, where the plurality of lateral void features are spaced apart in the lengthwise direction L₁₀ of the tread. It is also shown that each of the plurality of lateral void features 16 includes a groove portion 18 and a sipe portion 20 arranged along each length L₁₆, the groove portion forming a groove and the sipe portion forming a sipe. Each of the groove portion 18 and the sipe portion 20 are located at different locations along the length L₁₆ of the lateral void feature 16.

It is appreciated that the lateral void features may be arranged at any location along the tread. For example, with reference again to FIG. 1, lateral void features 16-1 are arranged along a shoulder rib R₁₀-1 in a spaced-apart configuration between shoulder tread blocks 12-1, lateral void features 16-2 are arranged along an intermediate rib R₁₀-2 in a spaced-apart configuration between intermediate tread blocks 12-2, lateral void features 16-3 are arranged along a central rib R₁₀-3 in a spaced-apart configuration between central tread blocks 12-3. These lateral void features 16-1, 16-2, and 16-3 are shown in greater detail in FIGS. 2-4.

In FIG. 2, a perspective view of a shoulder lateral void feature 16-1 is shown as a volume of the void it forms in the tread 10 of FIG. 1. In FIG. 3, a perspective view of an intermediate lateral void feature 16-2 is shown as a volume of the void it forms in the tread 10 of FIG. 1. In FIG. 4, a perspective view of a central lateral void feature 16-3 is shown as a volume of the void it forms in the tread 10 of FIG. 1. In each, for each lateral void feature 16, groove portion 18 and sipe portion 20 are arranged along length L₁₆. With specific regard to FIG. 4, central lateral void feature 16-3 has a second groove portion 18-2 spaced apart from a first groove portion 18-1, each separated by sipe portion 20.

In each embodiment of the lateral void feature shown in FIGS. 1-4, each lateral void feature 16 is shown to have a variable thickness T₁₆. More so, each of groove portion 18 and sipe portion 20 have a particular thickness T₁₈, T₂₀ (also referred to as a width), length L₁₈, L₂₀, and height H₁₈, H₂₀, respectively. Each such thickness extends in a direction perpendicular to the direction of the lateral void feature length L₁₆ and height H₁₆. As noted previously, in any embodiment, any groove and sipe portion may be shaped and sized in any manner desired. Accordingly, each groove and sipe portion may have any thickness, length, and height desired, each of which may be constant or variable across each respective portion. For example, in the embodiments of FIGS. 2-4, for each lateral void feature 16, the thickness T₁₈ of each groove portion 18 is constant over the length L₁₈ and height H₁₈ of each groove portion, as is the height H₁₈ of each groove portion 18 over the length L₁₈ and thickness T₁₈ of each groove portion. As for the sipe portion 20 in each exemplary embodiment shown in FIGS. 2-4, each sipe portion has a variable thickness T₂₀. While a variable thickness may be provided by other manners, in the embodiments shown, the variable thickness is at least partially provided by the sipe portion 20 including a thicker portion 22 extending around a perimeter of a reduced thickness portion 24, the thicker portion having a thickness greater than a thickness of the reduced thickness portion. This can be more clearly observed in FIG. 5, which is a sectional view of the sipe portion shown in FIG. 4. Both the thicker portion 22 and the reduced thickness portion 24 are shown to have a constant thickness. Still, the thickness T₂₂ of the thicker portion 22 extends along a linear path in both a direction of the lateral void feature length L₁₈ and height H₁₈, while the thickness T₂₄ of the reduced thickness portion 24 is shown to extend along an undulating path in both a direction of the lateral void feature height and length. As discussed above, other variations are contemplated and within the confines of this invention.

As noted above, in certain embodiments, for any lateral void feature, a transitional portion may be arranged between the groove portion and the sipe portion. For example, with reference again to FIGS. 2-4, a transitional portion 26 has a length L₂₆ extending between and connecting the groove portion 18 and the sipe portion 20. The transitional portion 26 has a variable thickness T₂₆ that varies along the length L₁₆ of the corresponding lateral void feature. The variable thickness T₂₆ is measured in a direction perpendicular to both the length L₁₆ and a height H₁₆ of the corresponding lateral void feature. In the embodiment shown, the variable thickness T₂₆ tapers non-linearly (that is, variably) from the groove portion 18 and to the sipe portion 20. In other variations, the height and length of the transitional portion taper linearly or non-linearly from the groove portion and to the sipe portion, whether or not the variable thickness tapers linearly or non-linearly.

As stated previously, other variations of the lateral void feature are contemplated.

For example, a location of increased thickness, such as a groove or thickened sipe, may be connected to, or included with, any of the groove portion, transitional portion, and, sipe portion. With reference to an exemplary embodiment in FIG. 6A, a location of increased thickness 28 is connected to the sipe portion 20 at a location within the tread depth, and more specifically, at a terminal location or bottom of the sipe portion and spaced apart from the outer, ground-engaging side of the tread in a depthwise direction of the tread thickness. This location of increased thickness 28 forms a submerged thickened sipe or groove. Accordingly, the variable thickness T₂₆ of the transitional portion 26 varies (increases) as the transitional portion extends in the depthwise direction T₁₀ of the tread. It is also noted that the sipe portion is centrally located across a width of the lateral void feature. By further example, with reference to FIG. 6B, in this exemplary embodiment, an area of increased thickness 28 is connected to each of the groove portion 18, the transitional portion 26, and the sipe portion 20 at a location within the tread depth. This location of increased thickness 28 forms a thickened sipe or a groove, for example. In the particular embodiment shown, the thickened portion 28 forms a submerged groove arranged at a bottom of each of the plurality of lateral void features 16, the submerged groove having a length extending along the length L₁₆ of each corresponding lateral void feature and being spaced apart from the outer, ground-engaging side of the tread by a portion of the tread thickness. In the embodiment shown, the length of the submerged groove extends the substantial full length of the lateral void feature.

By further example, a location of reduced thickness, such as a sipe or narrow groove, may be connected to, or included with, any of the groove portion, transitional portion, and, sipe portion. With reference to an exemplary embodiment in FIG. 6C, a location of reduced thickness 30 is connected to the groove portion 18 at a location within the tread depth, and more specifically, at a bottom or terminal location of the groove portion and spaced apart from the outer, ground-engaging side of the tread in a depthwise direction of the tread thickness. This location of reduced thickness 30 forms a submerged sipe or narrow groove. As for sipe portion 20, it includes a thickened portion 28 similarly shown and described in association with FIG. 6B, but which now extends partially along the length of the lateral void feature. Further, it is noted that the variable thickness T₂₆ of the transitional portion 26 varies (increases) as the transitional portion extends in the depthwise direction T₁₀ of the tread.

The lateral void feature may include other features, such as stone ejectors and/or groove bumpers, for example. With reference to the embodiment in FIG. 6D, for example, the groove portion includes a groove bumper 32. The groove bumper 32 comprises a protrusion that extends substantially across the width or thickness T₁₆ of a groove portion 18, to prevent the groove from collapsing or closing during tire operation. A sipe 34 having length L₃₄ may be arranged along the length L₃₂ of the protrusion (see FIG. 6E) and which extends across the full length L₃₂ and height H₃₂ of the bumper to form a discontinuity across a cross-section of the bumper when necessary to allow the molding element to be removed during demolding operations, or to reduces the tread stiffness when desired. In the present embodiment, a sipe 34 is arranged along the length of the protrusion, which is best observed in FIG. 6E. It is appreciated that the groove bumper may employ any sipe of any desired design, and which may be a planar or non-planar sipe. In the embodiment shown, a non-planar sipe 34 is employed, where the non-planar aspect is defined by an undulating thickness.

Finally, while FIGS. 2-4 and 6A-6E represent a lateral void feature arranged within a tread, each also represents a single molding element for forming the lateral void feature shown in the respective figure, since the void formed is a direct representation of the molding element used to form said void.

It is appreciated that any tread discussed herein may be arranged along an annular pneumatic tire, or may be formed separately from a tire as a tire component for later installation on a tire carcass, in accordance with any technique or process known to one of ordinary skill in the art. For example, the treads discussed and referenced herein may be molded with a new, original tire, or may be formed as a retread for later installation upon a used tire carcass during retreading operations. Therefore, when referencing the tire tread, a longitudinal direction of the tire tread is synonymous with a circumferential direction of the tire when the tread is installed on a tire. Likewise, a direction of the tread width is synonymous with an axial direction of the tire or a direction of the tire width when the tread is installed on a tire. Finally, a direction of the tread thickness is synonymous with a radial direction of the tire when the tread is installed on a tire. It is understood that the inventive tread may be employed by any known tire, which may comprise a pneumatic or non-pneumatic tire, for example.

It is appreciated that any of the tread features discussed herein may be formed into a tire tread by any desired method, which may comprise any manual or automated process. For example, the treads may be molded, where any or all discontinuities therein may be molded with the tread or later cut into the tread using any manual or automated process. It is also appreciated that any one or both of the pair of opposing discontinuities may be originally formed along, and in fluid communication with, the outer, ground-engaging side of the tread, or may be submerged below the outer, ground-engaging side of the tread, to later form a tread element after a thickness of the tread has been worn or otherwise removed during the life of the tire.

1. A tire tread comprising:
a length extending in a lengthwise direction, the lengthwise direction being a circumferential direction when the tread is arranged on a tire;
a width extending in a lateral direction, the lateral direction being perpendicular to the lengthwise direction;
a thickness extending in a depthwise direction from an outer, ground-engaging side of the tread, the depthwise direction being perpendicular to both the lengthwise direction and the widthwise direction of the tread;
a plurality of lateral void features each having a length extending primarily in the lateral direction of the tread, where the plurality of lateral void features are spaced apart in the lengthwise direction of the tread, and where each of the plurality of lateral void features include a groove portion and a sipe portion, the groove portion forming a groove and the sipe portion forming a sipe, each of the groove portion and the sipe portion located at different locations along the length of the lateral void feature,
where a submerged groove is arranged at a bottom of each of the plurality of lateral void features and/or where each of the plurality of lateral void features includes a groove bumper,
the submerged groove having a length extending along the length of each corresponding lateral void feature and being spaced apart from the outer, ground-engaging side of the tread by a portion of the tread thickness,
the groove bumper comprising a protrusion that extends substantially across the width of the groove portion to prevent the groove from collapsing or closing during tire operation, the groove bumper including a sipe arranged at a location along the length of the protrusion and extending across the full width and height of the protrusion to form a discontinuity across a cross-section of the bumper.

2. The tire tread of claim 1, where each of the plurality of lateral void features include a transitional portion extending between and connecting the groove portion and the sipe portion, the transitional portion having a variable thickness that varies along the length of the corresponding lateral void feature, where the variable thickness of the transitional portion is measured in a direction perpendicular to both the length and a height of the corresponding lateral void feature.

3. The tire tread of claim 2, where the variable thickness of the transitional portion non-linearly tapers as the transitional portion extends from the groove portion and to the sipe portion.

4. The tire tread of claim 2, where the variable thickness of the transitional portion varies as the transitional portion extends in the depthwise direction of the tread.

5. The tire tread of claim 1, where the thickness of the groove portion varies as the groove portion extends in the depthwise direction of the tread.

6. The tire tread of claim 1, where the sipe portion includes a thick portion and a thin portion, the thick portion extending around a perimeter of the thin portion and having a thickness greater than a thickness of the thin portion.

7. The tire tread of claim 6, where the thickness of the thin portion is 0.1 mm to 0.4 mm

8. The tire tread of claim 1, where each submerged groove extends the full length of the corresponding lateral void feature.

9. The tire tread of claim 1, where each of the plurality of lateral void features include the submerged groove and the groove bumper.

10. The tire tread of claim 1, where the groove portion for each of the plurality of lateral void features has a sipe arranged at a bottom of the corresponding lateral void feature.

11. The tire tread of claim 1, where for each of the plurality of lateral void features, the sipe portion is centrally located relative groove portion across the width of the corresponding lateral void feature.

12. The tire tread of claim 6, where the thick portion extends fully around the perimeter of the thin portion.

13. The tire tread of claim 6, where the thickness of the thick portion is greater than 0.4 mm and less than or equal to 10 mm.

14. The tire tread of claim 6, where a length of the thin portion is 10% to 80% of a width of a corresponding tread block and a length of the thick portion is 20% to 90% of the width of the corresponding tread block.

15. The tire tread of claim 6, where the thickness of one or both of the thick portion or thin portion is constant.

16. The tire tread of claim 6, where the thickness of one or both of the thick portion or thin portion is variable.

17. The tire tread of claim 6, where a cross-sectional thickness of one or both of the thick portion or thin portion extends linearly as each extends in the depthwise direction of the tread and/or as each extends along the length of the lateral void feature.

18. The tire tread of claim 6, where a cross-sectional thickness of one or both of the thick portion or thin portion extends non-linearly as each extends in the depthwise direction of the tread and/or as each extends along the length of the lateral void feature.

19. A method of forming a tread, the tread having: a length extending in a lengthwise direction, the lengthwise direction being a circumferential direction when the tread is arranged on a tire; a width extending in a lateral direction, the lateral direction being perpendicular to the lengthwise direction; and, a thickness extending in a depthwise direction from an outer, ground-engaging side of the tread, the depthwise direction being perpendicular to both the lengthwise direction and the widthwise direction of the tread, the method comprising the step of:
molding a plurality of lateral void features into the tread, each of the plurality of lateral void features having a length extending primarily in the lateral direction of the tread, where the plurality of lateral void features are spaced apart in the lengthwise direction of the tread, and where each of the plurality of lateral void features include a groove portion and a sipe portion, the groove portion forming a groove and the sipe portion forming a sipe, each of the groove portion and the sipe portion located at different locations along the length of the lateral void feature,
where a submerged groove is arranged at a bottom of each of the plurality of lateral void features and/or where each of the plurality of lateral void features includes a groove bumper,
the submerged groove having a length extending along the length of each corresponding lateral void feature and being spaced apart from the outer, ground-engaging side of the tread by a portion of the tread thickness,
the groove bumper comprising a protrusion that extends substantially across the width of the groove portion to prevent the groove from collapsing or closing during tire operation, the groove bumper including a sipe arranged at a location along the length of the protrusion and extending across the full width and height of the protrusion to form a discontinuity across a cross-section of the bumper.

20. The method of claim 19, where each of the lateral void features is formed separately from a single molding element.
